(19) United States
(12) Patent Application Publication
(10) Pub. No.: US 2010/0193997 A1
(43) Pub. Date: Aug. 5, 2010

(54) METHOD OF MAKING A MOLD AND MOLDED ARTICLE

(76) Inventors: Franklyn L. Frederickson, White Bear Lake, MN (US); Dennis E. Ferguson, Mahtomedi, MN (US)

Correspondence Address: 3M INNOVATIVE PROPERTIES COMPANY, PO BOX 33427, ST. PAUL, MN, 55133-3427, US

(21) Appl. No.: 11/916,468

(22) PCT Filed: Jun. 8, 2006
(86) PCT No.: PCT/US06/22570

§ 371 Date: Dec. 4, 2007

Related U.S. Application Data
(60) Provisional application No. 60/689,218, filed on Jun. 10, 2005.

(51) Int. Cl. B29C 33/42; B29C 59/02; B29C 35/08

(52) U.S. Cl. 264/400; 264/219; 264/293; 425/385

(57) ABSTRACT

The present invention is directed to a method of forming a mold for use in making molded articles having a plurality of microprojections. Additionally, the present invention provides a method of forming a molded article having a plurality of microprojections. In one aspect, a mold workpiece is provided, a tool having a tip with a shape corresponding to the microprojection, wherein the hardness of the tool is greater than that of the mold workpiece, is pressed into the mold workpiece and removed, thereby creating a mold with a microprojection cavity suitable for use in making the molded article.

### CROSS-REFERENCE TO RELATED APPLICATIONS

The present application claims priority to U.S. Provisional Application Ser. No. 60/689,218, filed on Jun. 10, 2005, which is incorporated herein in its entirety.

### FIELD

The present invention relates to a method of forming a mold for use in making a molded article. This invention also relates to forming a molded article having a plurality of microprojections.

### BACKGROUND

Only a limited number of molecules with demonstrated therapeutic value can be transported through the skin via unassisted or passive transdermal drug delivery. The main barrier to the transport of molecules through the skin is the stratum corneum (the outermost layer of the skin). Devices including microneedle and microprojection arrays of relatively small structures have been disclosed for use in connection with the delivery of therapeutic agents and other substances through the skin and other surfaces. These devices are typically pressed against the skin in an effort to pierce the stratum corneum by providing a plurality of microscopic slits to facilitate the transdermal delivery of therapeutic agents or the sampling of fluids through the skin.

Microneedle and microprojection devices may be fabricated from molds with micro-sized features. Molding processes to create molded articles with such microprojections have been previously disclosed. However, microprojections are very fine structures that can be difficult to prepare and the known microprojection molding processes all have certain disadvantages. In some cases, methods for molding have exhibited some success but they are generally time consuming, imprecise and/or expensive.

### SUMMARY OF THE INVENTION

Accordingly, it is desirable to develop a method for forming a mold for use in making a molded article, and a method of forming a molded article having a plurality of microprojections, that is cost-effective, easy to fabricate and produces precise arrays having micro-sized features and shapes.

The present invention is directed to a method of forming a mold for use in making molded articles having a plurality of microprojections. Additionally, the present invention provides a method of forming a molded article having a plurality of microprojections. The method of the present invention is suitable for reliably reproducing tool shapes into a microprojection array, producing microprojection arrays of a consistent height and depth, and producing microprojection arrays in an economical fashion.

In one embodiment, the present invention is directed to a method of forming a mold for use in making a molded article having at least one microprojection cavity, the method comprising: providing a mold workpiece; providing a tool having a tip with a shape corresponding to the microprojection wherein the hardness of the tool is greater than that of the mold workpiece; pressing the tool into the mold workpiece; and removing the tool from the mold workpiece, thereby creating a mold with a microprojection cavity suitable for use in making the molded article.

In another embodiment, the present invention is directed to a method of forming a mold for use in making a molded article having a plurality of microprojections, the method comprising: providing a mold workpiece; providing a tool having a tip with a shape corresponding to the microprojection wherein the hardness of the tool is greater than that of the mold workpiece; pressing the tool into the mold workpiece; and removing the tool from the mold workpiece, and repeating the steps of pressing and removing the tool from the mold workpiece thereby creating a mold with a plurality of microprojection cavities suitable for use in making the molded article.

In yet another embodiment, the present invention is directed to a method of forming a molded article having a plurality of microprojections, the method comprising: providing a mold with a plurality of microprojection cavities obtained from the method described above; depositing a material into the microprojection cavities to substantially fill the volume of the microprojection cavities; and removing the material from contact with the microprojection cavities, thereby forming the molded article having a plurality of microprojections.

In one aspect, the foregoing methods may further comprise the steps of forming a pilot hole in the mold workpiece and aligning the tool with the pilot hole prior to pressing the tool into the mold workpiece to form the microprojection cavity.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

In the description of the preferred embodiment, reference is made to the various Figures, wherein:

FIG. 1A shows a side view of one embodiment of a mold impressioning apparatus with a tool useful in an impressioning method according to the invention.

FIG. 1B shows an enlarged view of a mold impressioning apparatus with a tool useful in an impressioning method according of the present invention.

FIG. 1C shows an enlarged view of a tool and a mold assembly useful in an impressioning method according to the present invention.

FIG. 2 shows a side view of a tool according to one embodiment of the present invention.

FIG. 3 shows a cross-sectional view of a tool pressed into a mold workpiece according to one embodiment of the present invention.

FIG. 4 shows a cross-sectional side view of mold with a plurality of microprojection cavities produced by a molding process according to one embodiment of the present the invention.

FIG. 5 is a cross-sectional side view of an embodiment of a molded article having a plurality of microprojections.

FIG. 6 is a top view of an embodiment of a microprojection array of the present invention.

FIG. 7 is a side view of a mold workpiece with a pilot hole.

FIG. 8 is a side view of a mold workpiece with an impressioned microprojection cavity.

FIG. 9 is a scanning electron micrograph of the microneedle array of Example 8.

FIG. 10 is a scanning electron micrograph of a single microneedle of Example 8

### DETAILED DESCRIPTION OF THE INVENTION

Although the present invention will be described with reference to the embodiments shown in the drawings, it shall be understood that the present invention may be embodied in many alternate forms. In general, the mold impressioning apparatus promotes the ability to reproduce tool shapes for a microprojection array, produce microprojection arrays of a consistent height and depth, and produce microprojection arrays in an economical fashion. “Microprojection” refers to the specific microscopic structure associated with an array that is capable of piercing the stratum corneum to facilitate the transdermal delivery of therapeutic agents or the sampling of fluids through the skin.

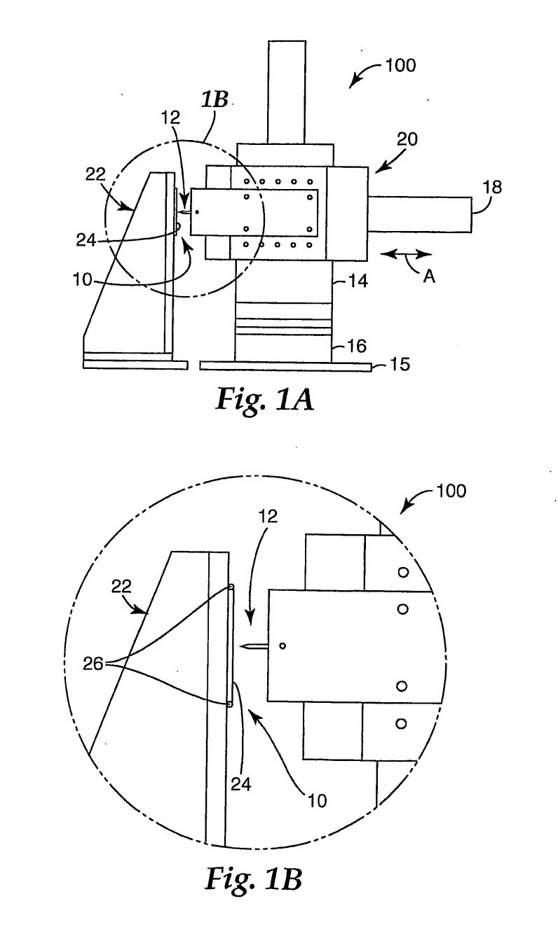

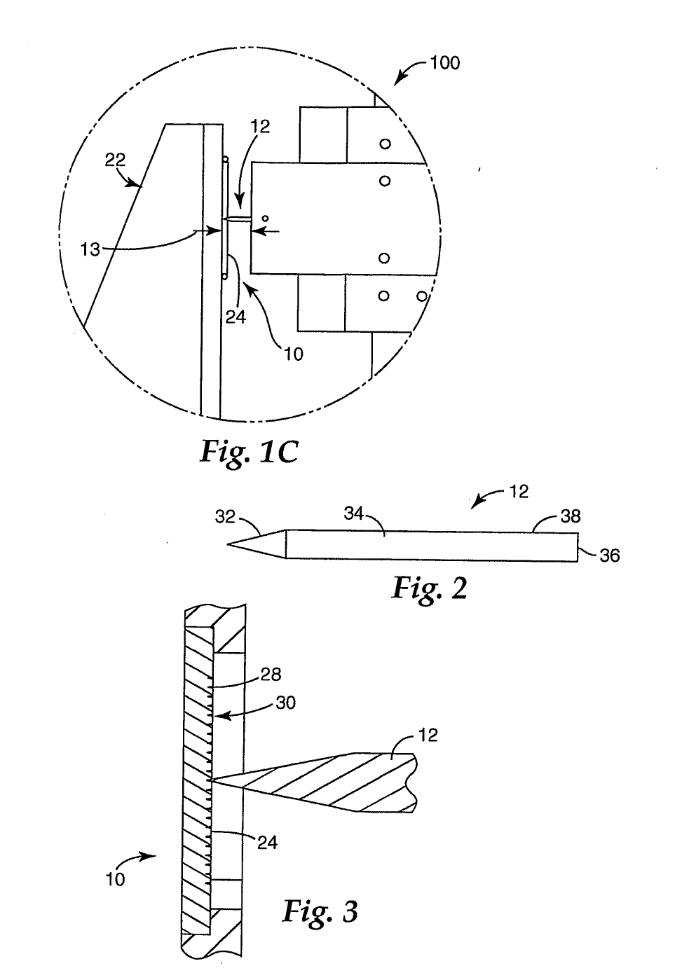

Referring to the Figures, FIG. 1A is a side view of a mold impressioning apparatus 100 incorporating features of the present invention. Also shown is a mold workpiece 10 and a tool 12 according to the present invention. As shown in FIG. 1A, the mold impressioning apparatus 100 includes a tool assembly 20 (which includes a tool 12), and a workpiece assembly 22. In one embodiment in FIG. 1B, the mold workpiece may be securely mounted to the workpiece assembly by clamps 26 or any other suitable mechanism to hold the mold workpiece in place during the impressioning process. “Impressioning” refers to the act of pressing and removing the tool through the mold surface into the mold workpiece to produce a cavity or recess that corresponds to the form and shape of the tool, and to the shape of the microneedle projection to be made. The workpiece assembly is stationary relative to the mold workpiece. In FIG. 1B, the mold workpiece includes a mold surface 24 into which a tool is inserted, as will be described more fully hereinafter.

The tool assembly 20 of FIG. 1A consists of a tool 12 capable of penetrating the mold workpiece 10, and an alignment and measurement device 18 (which may be, but is not limited to, a micrometer) that may be employed to align and measure the penetration distance by the tool into the mold workpiece. The tool assembly is configured to receive the tool. A moving linear stage 14 supports the tool assembly and connects the tool assembly to a fixed mounting stage 16 by a suitable drive means. The drive means may include any suitable actuator for example, a linear, pneumatic drive mechanism, or manual repositioning of the moving linear stage. In one embodiment, the moving linear stage is movably mated to the fixed mounting stage such that the tool assembly 20 is movable back and forth in the direction indicated by the arrow “A.” The movement of the linear stage permits the tool to penetrate the mold workpiece at varying depths to provide a microprojection cavity of the desired depth. The tool may be oriented at an angle with respect to the mold workpiece. It should be noted that the orientation of the moving linear stage as shown is arbitrary, but in some instances the moving linear stage is perpendicular to the workpiece assembly. In one embodiment, the tool is oriented perpendicular to the mold workpiece such that a larger density of cavities per unit area of the mold workpiece can be provided, if desired.

In preparation for the impressioning process, the tool assembly 20 and workpiece assembly 22 may be spaced horizontally apart from each other by a gap that is slightly wider than the height of the tool 12 so as allow insertion and removal of the tool from the tool assembly or mold workpiece as shown in FIG. 1A. When the moving linear stage 14 onto which the tool assembly is mounted travels in the direction indicated by the arrow “A,” the protruding tool (as shown) contacts the mold workpiece. After contact, as shown in FIG. 1C, the protruding tool continues to be pressed into the mold workpiece and is stopped when the tool assembly is at a desired distance 13 from the mold assembly and the tool has penetrated the mold workpiece at a desired depth. The tool assembly is then separated from the workpiece assembly, and the tool is removed from the mold workpiece, thereby creating a microprojection cavity or an impression of the tool.

Referring to FIG. 2, the tool 12 comprises a microscopic tip 32 and a tool shaft 34. The tool 12 refers to a device having the final geometry of the microprojection array (e.g. microprojections). The tool may comprise a microscopic tip integral to a tool shaft. The microscopic tip may be brazed or bonded to the tool shaft. The brazing of the microscopic tip may be done in such a way that the temperature in the tool shaft will remain below the limit where a softening of the microscopic tip material occurs, so as to not to interfere with the structural integrity of the tip. The completely manufactured tool may have a uniform hardness throughout the tool shaft, which may improve the wear resistance of the tool.

The tool has a surface contour that defines its features. In general, the tool may have any shape or geometry. The tool may be prepared by a number of methods, including diamond turning of a metal sheet to form a surface having protrusions with any of a variety of shapes, for example, pyramids, cones, crescents, or pins. Other suitable tool forming methods include, but are not limited to, polishing, ion beam machining, and electrode discharge machining. The tool 12 includes a base 36 on a distal surface 38 terminating above the distal surface in a tip 32. Although, as shown, the base is rectangular in shape, it will be understood that the shape of the tool and its associated base may vary.

In one embodiment, the tool has a relatively large shaft so that it may be conveniently handled. The shaft, for example, may be from about 0.5 cm to about 10 cm long and have a width of about 0.2 cm to about 2.0 cm, although any size shaft may be suitable. The shaft may be tapered along its full length, although it is often desirable that a portion of the shaft have a relatively constant cross-section, as this may aid in mounting the shaft in the tool assembly. As shown in FIG. 2, the shaft 34 may be uniform along most of its length and then have a tapered portion that terminates in a tip 32. The tip 32 that corresponds to the cavity formed in the mold workpiece will typically comprise only a small portion of the tapered end of the shaft. The height is selected for the particular application, accounting for both the inserted and uninserted portion of the microscopic tip.

In another embodiment, the tool may comprise a plurality of tips aligned so that more than one cavity may be formed in the mold workpiece during a single impressioning step. Such a tool, for example, may have an array of tool tips configured to resemble the array of cavities to be formed in the mold workpiece. In such an instance, a single impressioning step can be performed to create the desired array of cavities in the mold workpiece.

The microscopic tip of the tool can have a variety of configurations. The tip may be symmetrical or asymmetrical about the longitudinal axis of the tool shaft. In one embodiment, the tips are beveled. In another embodiment, the tip portion is tapered, as shown in FIG. 3. In yet another embodiment, the tapered microscopic tip is in the shape of a pyramid on a shaft portion having a square cross-section, such that the microprojection is in the shape of an obelisk. The microscopic tip can be rounded, and the tool and/or shaft may have other shapes, as well. The beveled or obelisk structures may advantageously provide better mechanical properties than fully tapered microprojections. It is the shape of the microscopic tip that determines the final shape of the microprojection obtained when using the mold.

In one embodiment, the microscopic tip 32 has a height that is less than 50%, often less than 10%, and sometimes less than 1% of the height of the total height of the tool shaft. The microscopic tip may have a conical shaft, which in one embodiment, may lead to the production of stronger microprojections. In another embodiment, the height of the microscopic tip of the tool is greater than 10 microns, in some embodiments greater than 40 microns, and in other embodiments greater than 100 microns. In another embodiment, the height of the microscopic tip of the tool is less than 1000 microns, in some embodiments less than 500 microns, and in other embodiments less than 250 microns.

The microscopic tip 32 may be coated to improve resistance to wear and impact, and may also be characterized by a hardness value, such as Vickers hardness. The Vickers hardness of the tool with a microscopic tip has a greater Vickers hardness value than the mold workpiece in order to achieve effective penetration into the mold workpiece, as will be described more fully hereinafter.

In one embodiment, the microscopic tip is hardened or anodized by coating with a material valued for its strength and/or resistance to chemical attack. The microscopic tip may be coated with or otherwise formed from certain materials, such as silicon carbide, tungsten carbide, titanium carbide, and/or hardened steel alloys. In one instance, diamond may be bonded to the tool shaft to form the microscopic tip.

Referring to FIG. 3, the mold workpiece 10 includes a mold surface 24 into which the tool 12 is inserted to form microprojection cavities which may be used to form a microprojection array. The mold workpiece 10 may be made to include integrally formed microprojection cavities that are arranged in a plurality of rows and columns and are substantially spaced apart at a uniform distance. The workpiece can include a variety of microprojection cavities with varying characteristics, for example, various depths, diameters, cross-sectional shapes, and spacings between the microprojection cavities. In one embodiment, the microprojection cavities have varying depths to allow the resulting microprojections to penetrate the skin at different depths (not shown).

The mold workpiece can have nearly any shape and configuration. In one embodiment, the mold workpiece is substantially flat. In another embodiment, the mold workpiece can be curved, convex or concave over portions of the surface or over the entire surface.

The method for forming a mold workpiece with microprojection cavities 10 may involve a plurality of individual tools used during the impressioning process to produce several microprojection cavities and eventually a microprojection array in the mold workpiece simultaneously. The number of individual microprojection cavities produced by a tool may be, for example, 100 or more, often 250 or more, and in some instances 500 or more. In some embodiments, using a single tool allows for adaptations and changes in the array pattern without the expense of costly tooling changes. In some embodiments, multiple tools may be used to form microprojection cavities as discussed more fully hereinafter.

The mold workpiece is selected based on its material characteristics and may be based on a variety of factors including the ability of the material to accurately reproduce the desired pattern; the strength and toughness of the material when formed into the workpiece; hardness of the material, etc. The mold workpiece 10 of FIG. 3 may be prepared from a variety of materials that include, but are not limited to, copper, steel, aluminum, brass, and other heavy metals. In one embodiment, the mold workpiece is soft enough to allow impressions to be formed therein from the tool while hard enough to limit deformation during subsequent use.

The mold workpiece and the tool have relative hardnesses permitting the tool to provide microprojection cavities in the mold workpiece. Hardness is the property of a mold workpiece or tool which gives it the ability to resist being permanently deformed (bent, broken, or otherwise have its shape changed) when a load is applied. The greater the hardness of the mold workpiece or tool, the greater resistance it has to deformation. In some instances, the hardness of the mold workpiece or the tool may be characterized by a Vickers surface hardness value, which is measured according to the Japanese Industrial Standard Z2244 “Vickers hardness test”, under a specified load for a specific period of time.

The Vickers hardness test method consists of indenting the test material, for example the mold workpiece, with a diamond indenter in the form of a right pyramid with a square base and an angle of 136° between opposite faces and subject to a load between 1 to 100 kilogram-force. The full load is normally applied for 10 to 15 seconds. The two diagonals of the indentation left in the surface of the material after removal of the load are measured using a microscope and their average calculated. The area of the sloping surface of the indentation is calculated. The Vickers hardness is the quotient obtained by dividing the kilogram-force load by the square millimeter area of indentation. The Vickers number (HV) is calculated using the following formula:

HV=1.854(F/D²),

with F being the applied load (measured in kilograms-force) and D² is the area of the indentation (measured in square millimeters).

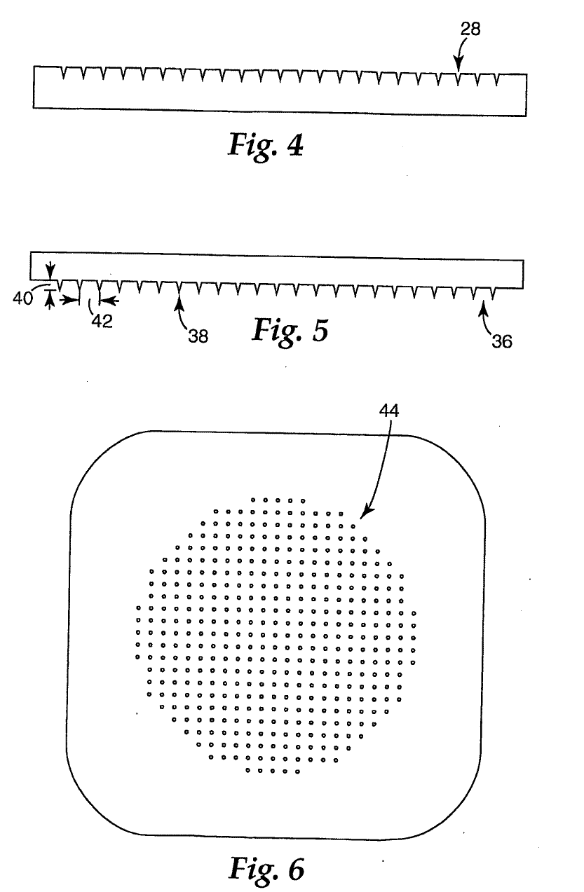

The hardness of the tool and the mold workpiece are key factors for the impressioning process. As shown in FIG. 4, the above impressioning process may be repeated to create a mold workpiece 10 with a plurality of microprojection cavities 28 in a desired pattern (as discussed more fully hereinafter). The mold workpiece is suitable for use in making a molded article as shown in FIG. 5. As shown, the microprojection cavities are integrally formed into the mold workpiece and may extend perpendicular or at an angle to the plane of the mold workpiece. The microprojection cavities can be arranged in a plurality of rows and columns that are spaced apart a uniform distance. For example, the microprojection cavities may be arranged in uniformly spaced rows placed in a rectangular arrangement.

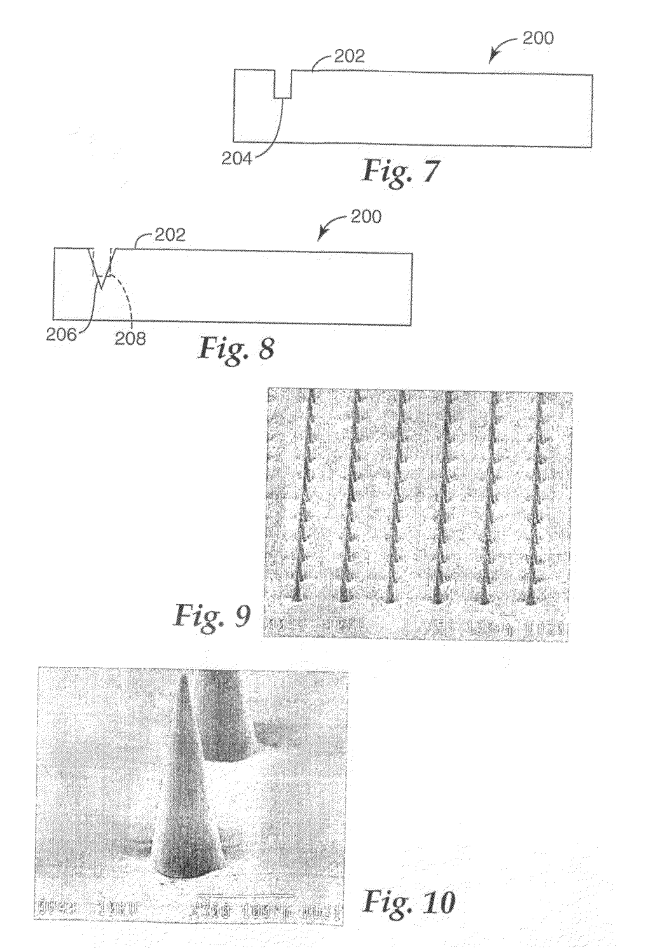

In one embodiment, it may be desirable to form rough, pilot holes in the mold workpiece prior to making an impression with the tool. For example, electrode discharge machining, EDM, may be used to form a small, cylindrical hole in a mold workpiece. The pilot hole formed by EDM may have a volume of about equal to or less than the volume of the desired microcavity to be formed. The tool may then be pressed into the pilot hole so that the shape of the microcavity conforms to the tool. This process is shown schematically in FIGS. 7 and 8. A pilot hole 204 may be formed by EDM in the surface 202 of a mold workpiece 200. A tool (not shown) with a conical tip may then be pressed into the pilot hole 204 to form a conical cavity 206 in the surface 202 of a mold workpiece 200. The original dimensions of the pilot hole 208 are shown as dashed lines in FIG. 8.

Pilot holes with shapes other than cylindrical may be also be employed, for example, holes having square or rectangular openings and/or holes that are tapered. In one embodiment, a pilot hole may be formed to define the shape of the upper part of an eventual microcavity (i.e., the portion of the microcavity that will correspond to the base of a molded microneedle). The impressioning tool may be subsequently aligned with the pilot hole and pressed into the mold workpiece to define the lower part of the microcavity. Such a microcavity may be suitable for molding microneedles having a two-step structure, for example, a microneedle having a small tip portion that protrudes from the generally flat surface of a larger microneedle base.

EDM may typically be used to form small holes in very hard materials, such as steel, but EDM lacks the ability to make microprojection cavities having very precise features. However, formation of a pilot hole with EDM reduces the amount of material in the mold workpiece that must be deformed by the tool. Although the amounts of material in the mold workpiece deformed by the tool are typically quite small even in the absence of a pilot hole (e.g., a typical cavity may have a depth of about 250 microns and an opening with a maximum width of about 100 microns), it may be desirable to reduce the amount of material that needs to be deformed. This may lead, for example, to improved tool life and/or minimization of deformation in the substrate of the mold workpiece surrounding the cavity.

In one embodiment, the pilot holes may be formed one at a time in any desired pattern and a tool may then be subsequently pressed into the pilot hole to form the desired final shape. In another embodiment, an EDM electrode may be formed having the general shape of the desired microprojection array and used to foi an array of pilot holes in a single EDM processing step.

In one embodiment the mold may be configured so as to have multiple, individual mold cavities, each mold cavity having a negative image of a microneedle array, such that the result of a single molding cycle produces multiple microneedle arrays. The number of individual mold cavities may be, for example, 4 or more, often 8 or more, and in some instances 32 or more. The injection pressure with which the molten polymeric material is injected into the mold cavities may be adjusted accordingly depending on the shape, size, and number of cavities being filled. Further details regarding the molding process are described below.

After the mold with a plurality of microprojection cavities is formed by the impressioning method described above, the molded article of FIG. 5 is produced as described more fully hereinafter. A molding material is deposited into the microprojection cavities 28 of the mold workpiece of FIG. 4 to substantially fill the volume of the cavities.

To begin the molding process to produce the molded article, a material is deposited into the microprojection cavities to substantially fill the volume of the cavities. Due to the structure of the cavity, the recesses of mold cavity may not always completely fill during the molding process. Residual air can be present in the mold cavity, forming air bubbles and preventing the fill material from completely filling the recesses in the mold. The residual air in the mold cavity should be removed during molding in order to form the highest quality devices. Accordingly, the molding can be performed under vacuum to remove any residual air in the mold and to allow the polymer or other fill material to completely enter the recesses of the mold. Additionally, the microprojection cavities may be provided with a vent to allow the residual air to escape or other venting procedures may be used to improve the filling of the cavities. The venting procedures may be used independent from or in conjunction with the vacuum processing.

There are a wide range of materials that may be deposited into the microprojection cavities during the molding process, including metals, ceramics, semiconductor materials, and composites, but preferably the microprojections are formed of a polymer, and in some instances, a biocompatible polymer. The polymer can be biodegradable or non-biodegradable. Examples of suitable biocompatible, biodegradable polymers include poly(lactide)s, poly(glycolide)s, poly(lactide-co-glycolide)s, polyanhydrides, polyorthoesters, polyetheresters, polycaprolactones, polyesteramides, poly(butyric acid), poly(valeric acid), polyurethanes and blends thereof. Representative non-biodegradable polymers include polyacrylates, polymers of ethylene-vinyl acetates and other acyl substituted cellulose acetates, non-degradable polyurethanes, polystyrenes, polyvinyl chloride, polyvinyl fluoride, poly(vinyl imidazole), chlorosulphonate polyolefins, polyethylene oxide, and copolymers thereof. Suitable polymers include, for example, polyester, e.g., polyethylene terephthalate (PET), glycol modified polyethylene terephthalate (PETG); polyimide, e.g., polyetherimide; polycarbonate; and mixtures thereof.

In one embodiment, the deposited material should have sufficient mechanical strength to remain intact for delivery of drugs, or serve as a conduit for the collection of biological fluid while being inserted into the skin.

The manufacturing molding processes for filling the microprojection cavities may include, for example, self-molding, micromolding, thermocycling injection molding, injection-compression, microembossing, and microinjection techniques. In the “self-molding” method, a plastic film (such as a polymer) is placed on an array, the plastic is then heated, and plastic deformation due to gravitational force causes the plastic film to deform and create the microprojection structure. Using this procedure, only a single mold-half is required. When using the micromolding technique, a similar microarray is used along with a second mold-half, which is then closed over the plastic film to form the microneedle structure. Details on thermocycling injection molding may be found in International Patent Publication No. WO 2005/82596, the disclosure of which is herein incorporated by reference. Details on injection-compression molding may be found in co-pending and commonly owned U.S. Patent Application Ser. No. 60/634,319, filed on Dec. 7, 2004 and entitled METHOD OF MOLDING A MICRONEEDLE, the disclosure of which is herein incorporated by reference. The micro-embossing method uses a single mold-half that contains an array of conical cut-outs (microholes) which is pressed against a flat surface (which essentially acts as the second mold-half) upon which the plastic film is initially placed. In the microinjection method, a melted plastic substance is injected between two micro-machined molds that contain microholes and microarrays.

After the material is molded and removed from contact with the cavities, a molded article 36 as shown in FIG. 5 and having a plurality of microprojections is formed. By way of example, microprojections 38 can include needle or needle-like structures as well as other structures, such as blades or pins, capable of piercing the stratum corneum. The microstructure is also referred to as a “microneedle”, “micro array” or “microneedle array.” The resulting microprojections may be characterized by their aspect ratio. As used herein, the term “aspect ratio” is the ratio of the height 40 of the microprojection (above the substrate) to the maximum base dimension, that is, the longest straight-line dimension that the base occupies. In the case of a pyramidal microprojection with a rectangular base, the maximum base dimension would be the diagonal line connecting opposed corners across the base. In connection with the present invention, the microprojections have an aspect ratio of about 2:1 or more, in some instances, about 3:1 or more, and in other instances about 5:1. Adjacent microprojections 38 may be spaced apart from each other by a spacing 42, also referred to as “pitch”, that may be regular or irregular. Although any spacing may be employed, the spacing 42 between adjacent microprojections is typically between about one-half and ten times the height of the microprojection.

Another manner in which the microprojection cavities and corresponding microprojections made by a method of the present invention may be characterized is by length or height. The height of the microprojection cavities may be measured from the mold workpiece base. The microprojection cavities may have a height greater than about 90 percent of the corresponding height of the microscopic tip of the tool. In other embodiments, the microprojection cavities may have a height substantially the same (e.g., 95 percent to 105 percent) as the corresponding height of the microscopic tip of the tool. The microneedles are typically less than 1000 microns in height, often less than 500 microns in height, and sometimes less than 300 microns in height. The microneedles are typically more than 20 microns in height, often more than 50 microns in height, and sometimes more than 125 microns in height. In some embodiments, the base-to-tip height of the molded microprojections is about 100 micrometers or more as measured from the substrate surface.

In some embodiments, the microprojections are uniformly arranged in a microprojection array 44, as shown in FIG. 6. “Array” refers to the medical devices described herein that include one or more microstructures or microprojections (e.g., pyramidal needles) capable of piercing the stratum corneum to facilitate the transdermal delivery of therapeutic agents or the sampling of fluids through the skin. The array may optionally contain additional non-microstructured features, such as flanges, connectors, etc. In other embodiments, not shown, the microprojections are randomly arranged in a microprojection array. Microprojection arrays prepared by methods of the present invention may have utility for enhancing delivery of molecules to the skin, such as in dermatological treatments, vaccine delivery, or in enhancing immune response of vaccine adjuvants. In one aspect, the drug may be applied to the skin (e.g., in the form of a solution that is swabbed on the skin surface or as a cream that is rubbed into the skin surface) prior to applying the microprojection device. An array of microprojections can include a mixture of microprojections having, for example, various heights, diameters, cross-sectional shapes, and spacing between the microprojections.

In one embodiment, the microprojections of the array have a patient-facing surface area of more than about 0.1 cm² and less than about 20 cm², preferably more than about 0.5 cm² and less than about 5 cm². In one embodiment, the microneedle array shown may be applied to a skin surface in the form of a patch combining an array, a pressure sensitive adhesive and a backing. A portion of the substrate surface of the patch may be non-patterned or smooth (i.e., microneedles do not extend from a portion of the surface of the patch). In one embodiment, the non-uniform surface area (i.e., the area from which microneedles extend from the substrate) is more than about 1 percent and less than about 75 percent of the total area of the patch. In one embodiment the non-uniform surface has an area of more than about 0.10 square inch (0.65 cm²) to less than about 1 square inch (6.5 cm²). The microneedles and microneedle arrays may comprise any of a variety of configurations, such as those described in the following patents and patent applications, the disclosures of which are herein incorporated by reference. One embodiment for the microneedle arrays comprises the structures disclosed in United States Patent Application Publication No. 2003/0045837. The disclosed microstructures in the aforementioned patent application are in the form of microneedles having tapered structures that include at least one channel formed in the outside surface of each microneedle. The microneedles may have bases that are elongated in one direction. The channels in microneedles with elongated bases may extend from one of the ends of the elongated bases towards the tips of the microneedles. The channels formed along the sides of the microneedles may optionally be terminated short of the tips of the microneedles. The microneedle arrays may also include conduit structures formed on the surface of the substrate on which the microneedle array is located. The channels in the microneedles may be in fluid communication with the conduit structures. Another embodiment for the microneedle arrays comprise the structures disclosed in United States Patent Application Publication No. 2005/0261631 which describes microneedles having a truncated tapered shape and a controlled aspect ratio. Still another embodiment for the microneedle arrays comprise the structures disclosed in U.S. Pat. No. 6,091,975 (Daddona, et al.) which describes blade-like microprotrusions for piercing the skin. Still another embodiment for the microneedle arrays comprises the structures disclosed in U.S. Pat. No. 6,313,612 (Sherman, et al.) which describes tapered structures having a hollow central channel. Still another embodiment for the microarrays comprises the structures disclosed in U.S. Pat. No. 6,379,324 (Gartstein, et al.) which describes hollow microneedles having at least one longitudinal blade at the top surface of tip of the microneedle.

In another aspect, microprojection arrays prepared by methods of the present invention may have utility for enhancing or allowing transdermal delivery of small molecules that are otherwise difficult or impossible to deliver by passive transdermal delivery. Examples of such molecules include ionic molecules, such as bisphosphonates, preferably sodium alendronate or pamidronate; and molecules with physicochemical properties that are not conducive to passive transdermal delivery.

Drugs that are of a large molecular weight may be delivered transdermally when assisted by microprojection arrays. Increasing molecular weight of a drug typically causes a decrease in unassisted transdermal delivery. Microprojection arrays have utility for the delivery of large molecules that are ordinarily difficult to deliver by passive transdermal delivery. Examples of such large molecules include proteins, peptides, nucleotide sequences, monoclonal antibodies, DNA vaccines, polysaccharides, such as heparin, and antibiotics, such as ceftriaxone.

### EXAMPLES

Molds and molded articles were prepared as follows. An apparatus as generally shown in FIG. 1A was prepared. Three Aerotech ATS-0200 series linear ball screw stages were used to control x, y, and z movement of the tool. The stages had a travel distance of 50 mm, an accuracy of ±1 micron, a repeatability of ±1 micron, and a maximum load of 245 Newtons. The apparatus was computer driven with a standard desktop computer using a computer program designed to form 1056 equally spaced impressions in a square pattern in each workpiece.

Custom made carbide points were purchased from Bruce Diamond Corporation. The points were specified to be carbide coned tools with a point of a 20 degree included angle and sharp under 0.0002″ (5 microns) on a 0.125″ (3.18 mm) diameter by 1.5″ (3.81 cm) long shaft. Actual measured tip diameters averaged 8 microns. Aluminum in 1100 and 6061 grades was purchased from McMaster Carr in standard temper and 0.125″ (3.18 mm) thickness for use as the mold workpiece.

The range tested for impression depths was from 100 to 250 microns with a midpoint at 175 microns. Impressioning feed rate (i.e., the speed with which the tool was pressed into the workpiece) was varied from 1 mm/s to 10 mm/s. These rates are capable of producing an impressioned microneedle mold with 1056 cavities in approximately 45 minutes and 5 minutes, respectively. The aluminum grades of 1100 and 6061 represented Brinell hardness values of 36 and 103, respectively.

Each impressioned microneedle mold was then used to fabricate a molded microneedle array. Arrays were molded using a low-viscosity, two-part silicone having a 4-hour work life (GE RTV 615, available from GE Silicones, Waterford, N.Y.). The two-part product was mixed and poured over each mold with a gasket around the microstructured area to prevent overflow. The molds were placed in a vacuum jar and allowed to cure overnight. Molded microneedle arrays were examined with scanning electron microscopy and/or with an optical imaging system (an OGP® Avant Zip SmartScope®, available from Optical Gaging Products, Inc., Rochester, N.Y.) capable of capturing images at magnifications between 27× and 304×. The height of a silicone molded needle at each corner of the array was measured and the average of the 4 measurements is reported below as average needle height.

Measurements and images of the carbide point tip diameter were recorded before and after use. The distance across the tip was recorded as the tip diameter. The change in tip diameter was calculated as the difference between the before and after use measurements. Measurements were also taken of the resulting microneedle tip diameters on all four corners of the molded parts. Examples 1 to 10 produced complete arrays with fully formed microneedles. The tools used in Examples 11 and 12 fractured during the first impression and thus produced arrays having a single full depth cavity, while the remainder of the cavities had blunt tips with a diameter of 73 and 57 microns, respectively. Representative images of the microneedle array formed as Example 8 are shown in FIGS. 9 and 10.

TABLE 1

| | | | | Tip | Tip | Average |
|---|---|---|---|---|---|---|
| Example | Material | Depth | Rate | diameter | diameter | height |
| No. | type | [μm] | [mm/s] | start [μm] | end [μm] | [μm] |
| 1 | 1100 | 100 | 1 | 5 | 8 | 60 |
| 2 | 1100 | 100 | 10 | 11 | 13 | 92 |
| 3 | 1100 | 175 | 1 | 5 | 6 | 163 |
| 4 | 1100 | 175 | 10 | 8 | 8 | 163 |
| 5 | 1100 | 250 | 1 | 8 | 8 | 199 |
| 6 | 1100 | 250 | 10 | 5 | 6 | 200 |
| 7 | 6061 | 100 | 1 | 11 | 11 | 84 |
| 8 | 6061 | 100 | 10 | 8 | 19 | 95 |
| 9 | 6061 | 175 | 1 | 19 | 19 | 165 |
| 10 | 6061 | 175 | 10 | 9 | 9 | 148 |
| 11 | 6061 | 250 | 1 | 10 | 73 | 99 |
| 12 | 6061 | 250 | 10 | 5 | 57 | 100 |

The present invention has been described with reference to several embodiments thereof. The foregoing detailed description and examples have been provided for clarity of understanding only, and no unnecessary limitations are to be understood therefrom. It will be apparent to those skilled in the art that many changes can be made to the described embodiments without departing from the spirit and scope of the invention. Thus, the scope of the invention should not be limited to the exact details of the compositions and structures described herein, but rather by the language of the claims that follow.

We claim:

1. A method of forming a mold for use in making a molded article having at least one microprojection, the method comprising:
(i) providing a mold workpiece;
(ii) providing a tool having a tip with a shape corresponding to the microprojection wherein the hardness of the tool is greater than that of the mold workpiece;
(iii) pressing the tool into a surface of the mold workpiece; and
(iv) removing the tool from the mold workpiece, thereby creating the mold with a microprojection cavity suitable for use in making the molded article.

2. The method as claimed in claim 1, wherein the cavity has a depth from the surface of about 500 micrometers or less.

3. The method as claimed in claim 1, wherein the tip of the tool is coated.

4. The method as claimed in claim 3, wherein the tip is coated with a material selected from the group consisting of silicon carbide, diamond carbide, titanium carbide, hardened steel, and a mixture thereof.

5. The method as claimed in claim 1, wherein the tip of the tool has a substantially pyramidal shape.

6. The method as claimed in claim 1, wherein the tip of the tool has a substantially conical shape.

7. The method as claimed in claim 1, wherein the tool has a base and is tapered from the base to the tip distal from the base.

8. The method as claimed in claim 1 and further comprising the steps of forming a pilot hole in the mold workpiece and aligning the tool with the pilot hole prior to pressing the tool into the mold workpiece to form the microprojection cavity.

9. The method of claim 8 wherein the pilot hole is formed by electrode discharge machining.

10. The method of claim 8 wherein the pilot hole is formed by laser drilling.

11. The method as claimed in claim 1, wherein the tool comprises a plurality of tips, thereby forming a plurality of microprojection cavities in the mold.

12. The method as claimed in claim 1, further comprising repeating steps (iii)-(iv), thereby forming a plurality of microprojection cavities in the mold.

13. A method of forming a molded article having a plurality of microprojections, the method comprising:
(i) providing a mold with a plurality of microprojection cavities obtained from the method of claim 11 or 12;
(ii) depositing a material into the microprojection cavities to substantially fill the volume of the microprojection cavities; and
(iii) removing the material from contact with the microprojection cavities, thereby forming the molded article having a plurality of microprojections.

14. The method of claim 13, wherein the material comprises a polymeric material.

15. The method of claim 14, wherein the polymeric material is selected from the group consisting of polycarbonate, polyetherimide, polyethylene terephthalate, and a mixture of two or more of the foregoing.

16. The method as claimed in claim 13, wherein at least one microprojection has an aspect ratio of 2:1 or more.

17. The method as claimed in claim 13, wherein the height of at least one microprojection is about 500 micrometers or less.

18. The method as claimed in claim 13, wherein the molded article comprises a plurality of microprojections integrally formed with a substrate.

19. The method as claimed in claim 13, wherein the microprojections are uniformly arranged in a microprojection array.

20. A mold for use in making a molded article having at least one microprojection produce by the method as claimed in claim 1.
